(19) United States
(12) Patent Application Publication
(10) Pub. No.: US 2026/0327418 A1
(43) Pub. Date: Oct. 22, 2026

(54) PA RECYCLABLE THERMOPLASTIC MATERIAL BLEND COMPRISING POLY(ETHYLENE TEREPHTHALATE)

(71) Applicant: PERSTORP AB, Perstorp (SE)

(72) Inventors: David JAMES, Lund (SE); Peter JOHANSSON, Vankiva (SE); Magnus KOKKO, Perstorp (SE)

(73) Assignee: PERSTORP AB, Perstorp (SE)

(21) Appl. No.: 19/099,578

(22) PCT Filed: Jul. 10, 2023
(86) PCT No.: PCT/SE2023/050723

§ 371 Date: Jan. 29, 2025

(30) Foreign Application Priority Data
Aug. 1, 2022 (SE) 2230251-7

(51) Int. Cl. C08L 67/02; B29B 17/04; B29C 48/00; B29C 48/21; B29K 67/00; B29L 9/00

(52) U.S. Cl. CPC C08L 67/02; B29B 17/0412; B29C 48/022; B29C 48/21; B29B 2017/042; B29K 2067/003; B29L 2009/00; C08L 2205/025; C08L 2207/20

(57) ABSTRACT

A recycled thermoplastic composition with improved processing properties comprising laminated thermoplastic material, having two or more strata wherein at least one strata is composed of a copolymer between;
a,i) 1,2-ethanediol (EG),
a,ii) β,β,β′β′-tetramethyl-3,9-(2,4,8,10-tetraoxaspiro[5.5]undecane)diethanol (PSG) and
a,iii) benzene-1,4-dicarboxylic acid (PTA) and
b) at least one strata is derived from the said laminated thermoplastic material composed of poly(ethylene terephthalate) (PET),
   wherein the thermoplastic composition is grinded into flakes and possibly pelletized.

The invention also relates to a laminate composition comprising recycled blend material.

### FIELD OF THE INVENTION

The present invention relates to a thermoplastic material blend comprising poly(ethylene terephthalate) which is recyclable and easy to process.

### BACKGROUND OF THE INVENTION

It is well known in the art to produce different types of containers from poly(ethylene terephthalate) commonly abbreviated as PET. Among the containers produced bottles and trays can be mentioned. One problem with PET is that it is not able to withstand temperatures used for so called hot-fill application which historically have meant that the industry have been left with the only choice of glass, polycarbonate or polystyrene. These materials are all questionable from an environmental point of view. In an aim to solve the drawbacks different PET-like polymers with improved high temperature properties have been developed. These PET-like polymers are most often used together with traditional PET in a so-called A-B-A type laminate where the more temperature resistant PET-like polymers form the outer layers (A) and the traditional PET form the core layer (B). This core layer (B) most often constitutes more than 60% by weight of the laminate.

One problem with these kind of laminates are connected to recycling of the material. The possibility for recycling is indeed very important from an environmental point of view as a good material is reused and limited resources are saved. Typically the used laminate products are grinded into flakes, thoroughly rinsed and melted and formed into pellets for use in new products. As with many polymers, also the herein described polymers need to be dehumidified before they can be processed in injection molding or extrusion molding as blistering or even more severe problems in production will occur. It is known that many known such recycled materials as described above will agglomerate during the dehumidifying and will be impossible to process further due to this. Many of these polymers are also known to become hazy after recycling which means that they can only be used in new low-end packaging. There is thus a great need for a polymer composition that is easier to process after recycling and have mechanical and visual properties that are closer to so-called virgin material. Thermoplastic material available for recycling will be derived from mainly two sources. A first one is residual material from manufacturing of vacuum molded containers, blister packages etc. from laminated sheet material. Once the molded containers are punched free from the sheet a substantial amount of material remains. A second source worth mentioning is from existing recycling systems where end consumers can return emptied containers. Analogies to PET bottle recycling systems existing in many countries can be seen.

### DETAILED DESCRIPTION OF THE INVENTION

It has, through the present invention been made possible to recycle and process laminated products, where the resulting product has mechanical and processing properties that is on pair with virgin material. The invention accordingly refers to a recycled thermoplastic composition with sustainable processing properties, grinded into palletizable thermoplastic flakes. The invention is characterized in that the recycled thermoplastic composition originates from a material comprising laminated thermoplastic material, said laminated thermoplastic material comprising two or more strata wherein at least one strata is composed of a copolymer between;
a,i) 1,2-ethanediol (hereinafter EG),
a,ii) β,β,β′β′-tetramethyl-3,9-(2,4,8,10-tetraoxaspiro[5.5]undecane)diethanol (hereinafter PSG) and
a,iii) benzene-1,4-dicarboxylic acid (hereinafter PTA)
and wherein,
b) at least one strata is derived from the said laminated thermoplastic material composed of poly(ethylene terephthalate) (hereinafter PET).

The thermoplastic composition which from originally being a laminate between two different thermoplastic materials ending up as a blend of said thermoplastic materials have shown to have the necessary mechanical and optical properties to be fully usable in production of new laminates as herein disclosed.

The copolymer a) component is preferably present in the recycled thermoplastic composition in the range 0.5-40% by weight.

The laminate, i.e. the material to be recycled, comprising EG, PSG, PTA and PET, is present in a mix together with mono layer sheet material or bottles made from PET, wherein the laminate material comprises 1-40% by weight and monolayer PET material comprises 60-99% by weight of the mix.

The recycled thermoplastic composition is used for injection molding, extrusion molding and/or blow molding by using the same range of processing parameters as for PET.

The invention also relates to a thermoplastic laminate produced through co-extrusion having a core layer B and at least one outer layer A. The core layer B comprises at least 10% by weight originating from a recycled thermoplastic laminated material. Said recycled thermoplastic laminated material, before recycling, comprised at least two strata, wherein at least one strata is composed of a copolymer between;
a,i) 1,2-ethanediol (EG),
a,ii) β,β,β′β′-tetramethyl-3,9-(2,4,8,10-tetraoxaspiro[5.5]undecane)diethanol (PSG) and
a,iii) benzene-1,4-dicarboxylic acid (PTA)
and wherein,
b) at least one strata derived from the said laminated thermoplastic material is composed of poly(ethylene terephthalate) (PET).

Said recycled thermoplastic material is, after being mixed with PET, coextruded into a new laminate together with copolymer composed of EG, PSG and PTA.

The laminate is of A-B-A type, where B comprises the recycled thermoplastic material and A is the copolymer composed of EG, PSG and PTA.

The layer(s) A preferably constitutes 5-50% by weight of the laminate.

According to one embodiment of the invention the layer(s) A is/are made from virgin material and B comprises 0.5-10% by weight of recycled laminate material, remainder being ordinary PET.

According to another embodiment of the invention the layer(s) B comprises 1-8% by weight of recycled laminate material, remainder being ordinary PET.

The ordinary PET is suitably at least 50% by weight of recycled PET, more suitably at least 75% by weight of recycled PET.

### Embodiment Examples

A number of different thermoplastic laminates of A-B-A type which were produced through coextrusion were grinded into flakes and then pelletized, The composition of the A layer of the laminate is a co-polymer made from;
ai) 1,2-ethanediol (EG),
a,ii) β,β,β′β′-tetramethyl-3,9-(2,4,8,10-tetraoxaspiro[5.5]undecane)diethanol (PSG) and
a,iii) benzene-1,4-dicarboxylic acid (PTA).

The above copolymer is known on the market as Akestra™. Akestra™ exist in three different qualities; Akestra™ 90, Akestra™ 100 & Akestra™ 110.

The B layer of the laminate is made from poly(ethylene terephthalate) (PET).

Four different recycling compositions where tested with different ranges of standard PET material mixed with the A-B-A laminate in accordance with the below table 1. These tests were made to simulate PET recycling where for example PET bottles could be mixed with different levels of other type of PET based laminated packaging such as herein disclosed.

TABLE 1

| | | A-B-A | A = share of |
|---|---|---|---|
| Sample | (PET) | laminate* | the blend |
| number | (% by weight) | (% by weight) | (% by weight) |
| 1 | 90 | 10 | 2 |
| 2 | 80 | 20 | 4 |
| 3 | 70 | 30 | 6 |
| 4 | 60 | 40 | 8 |

*The A-B-A laminate comprises; A = EG/PSG/PTA, B = PET

The resulting pellets from samples 1, 3 & 4 where then analyzed for melting peak temperature, melting enthalpy, crystallization peak temperature and crystallization enthalpy, in comparison with 100% PET. The results are shown in Table 2.

TABLE 2

| | | | Melting | Crystalli- | |
|---|---|---|---|---|---|
| | | Melting | enthalpy | zation | Crystallization |
| | | peak | Delta H | peak | enthalpy |
| Sample | | (° C.) | (J/g) | (° C.) | delta H (J/g) |
| PET | First heating | 252 | 38 | 206 | 41 |
| (100%) | Second | 245 | 43 | | |
| | heating | | | | |
| 1; (90/10) | First heating | 251 | 41 | 196 | 37 |
| Recycled | Second | 243 | 37 | | |
| blend | heating | | | | |
| 3; (70/30) | First heating | 250 | 39 | 188 | 38 |
| Recycled | Second | 246 | 35 | | |
| blend | heating | | | | |
| 4; (60/40) | First heating | 251 | 41 | 191 | 38 |
| Recycled | Second | 247 | 35 | | |
| blend | heating | | | | |

It showed that the recycled blends have properties very similar to pure 100% PET and can accordingly be processed using the same range of process settings as with PET.

The recycled blends were further tested for agglomeration properties. Agglomeration is not desired and is known to occur during drying (de-hydration) of the pellets before manufacturing. Manufacturing includes injection molding, extrusion molding and blow molding. Any remaining water in the pellets will cause problems during molding. The most common is so-called blistering.

Two containers with the diameter of 130 mm and height of 160 mm were covered with aluminum foil on the bottom. Pellets from sample 2 (of table 1) were filled to a height of 50 mm in a first container while pellets from sample 4 (of table 1) where filled to a height of 50 mm in a second container. The top of the pellets where then covered with aluminum foil whereupon 9.5 kg weights, one for each container, with the diameter 125 mm were arranged on top of the aluminum foil covered pellets. The two prepared containers were then placed in an oven at the temperature of 210° C. for 90 minutes. After this 90 minute baking the containers with samples and weight were removed from the oven and allowed to cool. After the cooling period the weights were removed and the pellets were carefully poured out of the container under inspection to check for signs of agglomeration. It was found that the sample pellets did not show any tendency to agglomerate.

The above result show that any type of molding with the recycled blend material could be processed in all common types of manufacturing without modifying this equipment with no risk of clogging of feeding or plasticization units in the molding equipment.

The recycled blends were further tested for tensile strength and elongation. The tensile tests were done according to ISO 527-2 1 B to measure yield stress and strain, tensile strength and elongation at break. The equipment used was a Zwick Z10 Table top machine with a 10 kN load cell. A uniaxial extension rate of 50 mm/min has been used. Measurements were performed at 23° C. and 50% RH. Dog-bone-shaped sample specimens, ISO 527-3 type 5, for the tensile tests were injection molded, with a thickness of approximately 4 mm. Specimens for all tests were conditioned for at least three days at 23° C. and 50% RH before measurements. The tensile results are the average values of 5 specimens. Sample 1-4 refers to table 1, while PET* (for comparison) in the table refers to virgin non-recycled PET. The results are shown in table 3.

TABLE 3

| | | Tensile | | |
|---|---|---|---|---|
| | Stress | strength at | Elongation | Elongation |
| Sample | at yield | maximum | at yield | at maximum |
| 1 (90/10) | 57 | 57 | 8.9 | 9 |
| 2 (80/20) | 57 | 57 | 8.8 | 9 |
| 3 (70/30) | 58 | 58 | 8.8 | 9 |
| 4 (60/40) | 57 | 57 | 8.7 | 9 |
| PET* | 57 | 57 | 8.8 | 9 |

The results show that the mechanical properties of recycled laminated thermoplastic composition according to the present invention is very close, if not identical to virgin PET material. This shows that laminated thermoplastic material in accordance with the present invention can be recycled to a full extent. The latter is of course very advantageous from an environmental point of view.

The samples 1-4 (of table 1) where finally tested for optical appearance. The samples 1-4 where injection molded into 2.2 mm thick plates and extrusion molded into 0.4 mm thick plates respectively. Samples from virgin PET material was prepared using the same process for comparison. The samples where then optically evaluated for haziness. No notable difference in haziness could be detected on the set of 0.4 mm plates. On the 2.2 mm plates sample no 1 was found to be slightly less hazy than the PET comparison while sample no 2 was very similar to the PET comparison. Samples 3 and 4 was found to be slightly more hazy than the PET comparison.

1-11. (canceled)

12. Ground, pelletizable flakes with sustainable processing properties made from a recycled thermoplastic laminate material, the recycled thermoplastic laminate material comprising:
(a) at least one layer of a copolymer formed from:
(i) 1,2-ethanediol (EG);
(ii) β,β,β′,β′-tetramethyl-3,9-(2,4,8,10-tetraoxaspiro[5.5]undecane) diethanol (PSG); and
(iii) benzene-1,4-dicarboxylic acid (PTA); and
(b) at least one layer of poly(ethylene terephthalate) (PET).

13. The ground, pelletizable flakes of claim 12 comprising 0.5 to 40 wt. % of the copolymer (a).

14. The ground, pelletizable flakes of claim 12 comprising 1 to 40 wt. % of the copolymer (a) and 60 to 99 wt. % of the PET (b).

15. An injection molded, extrusion molded, or blow molded product produced from the ground, pelletizable flakes of claim 12.

16. A thermoplastic laminate produced through co-extrusion, the thermoplastic laminate comprising at least one outer layer (A) and a core layer (B), wherein the core layer (B) comprises at least 10 wt. % of recycled thermoplastic laminate material, the recycled thermoplastic laminate material comprising:
(a) at least one layer of a copolymer of:
(i) 1,2-ethanediol (EG);
(ii) β,β,β′,β′-tetramethyl-3,9-(2,4,8,10-tetraoxaspiro[5.5]undecane)diethanol (PSG); and
(iii) benzene-1,4-dicarboxylic acid (PTA); and
(b) at least one layer of poly(ethylene terephthalate) (PET).

17. The thermoplastic laminate of claim 16, wherein the thermoplastic laminate is an A-B-A type laminate, wherein:
A is a copolymer of (i) 1,2-ethanediol (EG), (ii) β,β,β′,β′-tetramethyl-3,9-(2,4,8,10-tetraoxaspiro[5.5]undecane)diethanol (PSG), and (iii) benzene-1,4-dicarboxylic acid (PTA); and
B comprises the at least 10 wt. % of the recycled thermoplastic laminate material.

18. The thermoplastic laminate of claim 16, comprising 5 to 50 wt. % of the at least one outer layer A.

19. The thermoplastic laminate of claim 16, wherein the at least one outer layer A is virgin material and the core B comprises 0.5 to 10 wt. % of the recycled thermoplastic laminate material with the remainer being PET.

20. The thermoplastic laminate of claim 19, wherein the core B comprises 1 to 8 wt. % of the recycled thermoplastic laminate material with the remainer being PET.

21. The thermoplastic laminate of claim 19, wherein the PET is at least 50 wt. % recycled PET.

22. The thermoplastic laminate of claim 19, wherein the PET is at least 75 wt. % recycled PET.

23. A method for making an injection molded, extrusion molded, or blow molded product comprising injection molding, extrusion molding, or blow molding the ground, pelletizable flakes of claim 12, or pellets formed from the ground, palletizable flakes, using process parameters appropriate for poly(ethylene terephthalate) (PET).

24. A method for recycling thermoplastic laminate material comprising
(i) grinding recycled thermoplastic laminate material into ground, pelletizable flakes with sustainable processing properties, wherein the recycled thermoplastic laminate material comprises:
(a) at least one layer of a copolymer formed from:
(i) 1,2-ethanediol (EG);
(ii) β,β,β′,β′-tetramethyl-3,9-(2,4,8,10-tetraoxaspiro[5.5]undecane)diethanol (PSG); and
(iii) benzene-1,4-dicarboxylic acid (PTA); and
(b) at least one layer of poly(ethylene terephthalate) (PET);
(ii) optionally, pellitizing the ground, pellitzable flakes from (i) to generate pellets; and
(ii) co-extruding the ground, pelletizable flakes from (i) or the pellets of (ii) with standard PET.
